(19) United States
(12) Patent Application Publication
(10) Pub. No.: US 2026/0213796 A1
(43) Pub. Date: Jul. 23, 2026

(54) METHODS, APPARATUSES AND SYSTEMS FOR INTELLIGENT REFLECTION SURFACE INSTALLED USER EQUIPMENT POSITIONING

(71) Applicant: Kyocera Corporation, Kyoto (JP)

(72) Inventors: Amit KALHAN, San Diego, CA (US); Henry CHANG, San Diego, CA (US)

(21) Appl. No.: 19/157,791

(22) PCT Filed: Dec. 1, 2023
(86) PCT No.: PCT/US2023/082209

§ 371 Date: Aug. 19, 2025

Related U.S. Application Data
(60) Provisional application No. 63/453,588, filed on Mar. 21, 2023.

(51) Int. Cl. H04B 7/04; H04W 64/00

(52) U.S. Cl. CPC H04B 7/04013; H04W 64/00

(57) ABSTRACT

Methods, apparatus and systems for user equipment positioning based on intelligent reflection surface are described. In one embodiment, a method performed by a first wireless communication node, includes: transmitting a respective one of a plurality of first signals to each of a first plurality of wireless communication nodes; transmitting a second signal to a wireless communication device, wherein the second signal comprises an indication to instruct the wireless communication device to reflect each of a plurality of third signals back towards a respective transmitting node using an Intelligent Reflecting Surface (IRS); transmitting a respective one of the plurality of third signals to the wireless communication device; and receiving a respective one of a plurality of first reports from a respective one of the first plurality of wireless communication nodes for positioning computation of the wireless communication device.

### TECHNICAL FIELD

The disclosure relates generally to wireless communications and, more particularly, to methods, apparatuses and systems for intelligent reflection surface (IRS) installed user equipment (UE) positioning.

### BACKGROUND

An IRS is a planar surface comprising a plurality of small, reconfigurable reflecting elements, each of which can induce a controllable amplitude, phase and/or polarization change to the incident signal independently, without need of baseband processing. IRSs are designed to reflect, refract, or scatter incoming electromagnetic waves in a way that optimizes signal strength, minimizes interference, and enhances overall wireless communication performance.

On the other hand, with the aim of providing high data rate with low-latency and reliable coverage in future generation communication systems, accurate and reliable UE positioning is a crucial aspect as UE positioning information can be used for allocating and managing transmission resources, delivering satisfactory Quality of Service (QoS) to users, enhancing spectrum efficiency, and performing handovers between different base stations (BSs) or cells. UE positioning in wireless communication systems is a challenging task due to various factors and constraints, which can impact the accuracy and reliability of positioning methods. Examples of key challenges in UE positioning include: multipath propagation causing signal delays and distortions, non-line-of-signal (NLOS) conditions, signal strength variability resulting in unstable received signal power, time synchronization requirement, and increased power consumption. Therefore, there is a need to develop new techniques for improving UE positioning accuracy and reliability while maintaining power consumption at a low level.

### SUMMARY

The exemplary embodiments disclosed herein are directed to solving the issues relating to one or more of the problems presented in the prior art, as well as providing additional features that will become readily apparent by reference to the following detailed description when taken in conjunction with the accompany drawings. In accordance with various embodiments, exemplary systems, methods, devices and computer program products are disclosed herein. It is understood, however, that these embodiments are presented by way of example and not limitation, and it will be apparent to those of ordinary skill in the art who read the present disclosure that various modifications to the disclosed embodiments can be made while remaining within the scope of the present disclosure.

In some embodiments, a method performed by a first wireless communication node, includes: transmitting a respective one of a plurality of first signals to each of a first plurality of wireless communication nodes, transmitting a second signal to a wireless communication device, wherein the second signal includes an indication to instruct the wireless communication device to reflect each of a plurality of third signals back towards a respective transmitting node using an IRS installed on the wireless communication device, transmitting a respective one of the plurality of third signals to the wireless communication device, wherein the wireless communication device is configured to: receive each of the plurality of third signals from a respective one of a second plurality of wireless communication nodes, and reflect each of the plurality of third signals back towards the respective one of the second plurality of wireless communication nodes in a respective same direction using the IRS, and receiving a respective one of a plurality of first reports from a respective one of the first plurality of wireless communication nodes for positioning computation of the wireless communication device.

In some embodiments, each of the plurality of first signals includes respective downlink-positioning reference signal (DL-PRS) configurations for each of the first plurality of wireless communication nodes, wherein the respective DL-PRS configurations include at least one of: positioning reference signal (PRS) resources, muting resources, a PRS pattern and a PRS periodicity, and a respective list of measurements to be reported in the respective one of the plurality of first reports, wherein the respective list of measurements includes at least one of: a Round-Trip-Delay (RTD), a Time-of-Arrival (ToA), a Received Signal Received Power (RSRP), an Angle-of-Arrival (AoA), and an Angle-of-Departure (AoD) for PRS transmission, and the respective transmitting node is a respective one of the second plurality of wireless communication nodes, wherein the second plurality of wireless communication nodes includes the first wireless communication node and the first plurality of wireless communication nodes.

In some embodiments, the plurality of first signals is transmitted based on a measurement initiation request sent from a location management server (LMS), wherein the measurement initiation request is one of: a new radio (NR) Reference Signal Received Power (RSRP) measurement initiation request, an NR Reference Signal Received Quality (RSRQ) measurement initiation request, an Enhanced Cell Identity (E-CID) measurement initiation request message, an Evolved Universal Terrestrial Radio Access Network Reference Signal Received Power (E-UTRA RSRP) measurement initiation request message, an Evolved Universal Terrestrial Radio Access Network Reference Signal Received Quality (E-UTRA RSRQ) measurement initiation request message, and an Observed Time Difference Of Arrival (OTDOA) measurement initiation request message.

In some embodiments, the indication in the second signal is: transmitted through system information block (SIB) signaling, transmitted through radio resource control (RRC) signaling, transmitted through medium access control-control element (MAC-CE) signaling, transmitted through downlink control information (DCI) signaling, transmitted via a paging message, or pre-configured in the wireless communication device.

In some embodiments, the respective one of the plurality of third signals includes a respective DL-PRS, wherein the respective DL-PRS includes at least one of: resource allocation information for downlink transmission, modulation and coding schemes, and pilot signals for positioning measurements. In some embodiments, the wireless communication device is in a non-CONNECTED state when the wireless communication device reflects each of the plurality of third signals back towards the respective one of the second plurality of wireless communication nodes using the IRS.

In some embodiments, the method performed by the first wireless communication node further includes: transmitting the plurality of first reports to a Location Management Server (LMS), wherein the LMS is configured to perform positioning computation for the wireless communication device using a trilateration positioning method based on the plurality of first reports.

### BRIEF DESCRIPTION OF THE DRAWINGS

Various exemplary embodiments of the present disclosure are described in detail below with reference to the following Figures. The drawings are provided for purposes of illustration only and merely depict exemplary embodiments of the present disclosure to facilitate the reader's understanding of the present disclosure. Therefore, the drawings should not be considered limiting of the breadth, scope, or applicability of the present disclosure. It should be noted that for clarity and ease of illustration these drawings are not necessarily drawn to scale.

FIG. 1A illustrates an exemplary wireless communication network, in accordance with some embodiments of the present disclosure.

FIG. 1B illustrates a block diagram of an exemplary wireless communication system, in accordance with some embodiments of the present disclosure.

FIG. 2 illustrates a signaling diagram between a plurality of base stations and user equipment for performing a method for user equipment positioning, in accordance with some embodiments of the present disclosure.

FIG. 3A illustrates an exemplary architecture of an intelligent reflecting surface for user equipment positioning, in accordance with some embodiments of the present disclosure.

FIG. 3B illustrates an exemplary reconfigurable reflecting element in an intelligent reflecting surface, in accordance with some embodiments of the present disclosure.

FIG. 3C illustrates an exemplary equivalent circuit of a positive-intrinsic-negative diode 360, in accordance with some embodiments of the present disclosure.

FIG. 4 illustrates another signaling diagram between a plurality of base stations and user equipment for performing a method for user equipment positioning, in accordance with some embodiments of the present disclosure.

FIG. 5 illustrates an example method for performing user equipment positioning, in accordance with some embodiments of the present disclosure.

FIG. 6 illustrates another example method for performing user equipment positioning, in accordance with some embodiments of the present disclosure.

### DETAILED DESCRIPTION OF EXEMPLARY EMBODIMENTS

Various exemplary embodiments of the present disclosure are described below with reference to the accompanying figures to enable a person of ordinary skill in the art to make and use the present disclosure. As would be apparent to those of ordinary skill in the art, after reading the present disclosure, various changes or modifications to the examples described herein can be made without departing from the scope of the present disclosure. Thus, the present disclosure is not limited to the exemplary embodiments and applications described and illustrated herein. Additionally, the specific order and/or hierarchy of steps in the methods disclosed herein are merely exemplary approaches. Based upon design preferences, the specific order or hierarchy of steps of the disclosed methods or processes can be re-arranged while remaining within the scope of the present disclosure. Thus, those of ordinary skill in the art will understand that the methods and techniques disclosed herein present various steps or acts in a sample order, and the present disclosure is not limited to the specific order or hierarchy presented unless expressly stated otherwise.

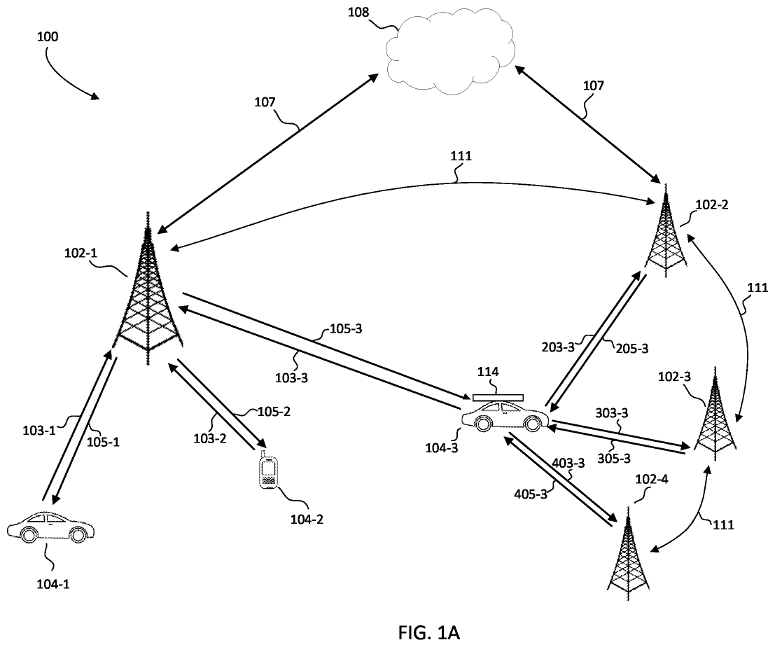

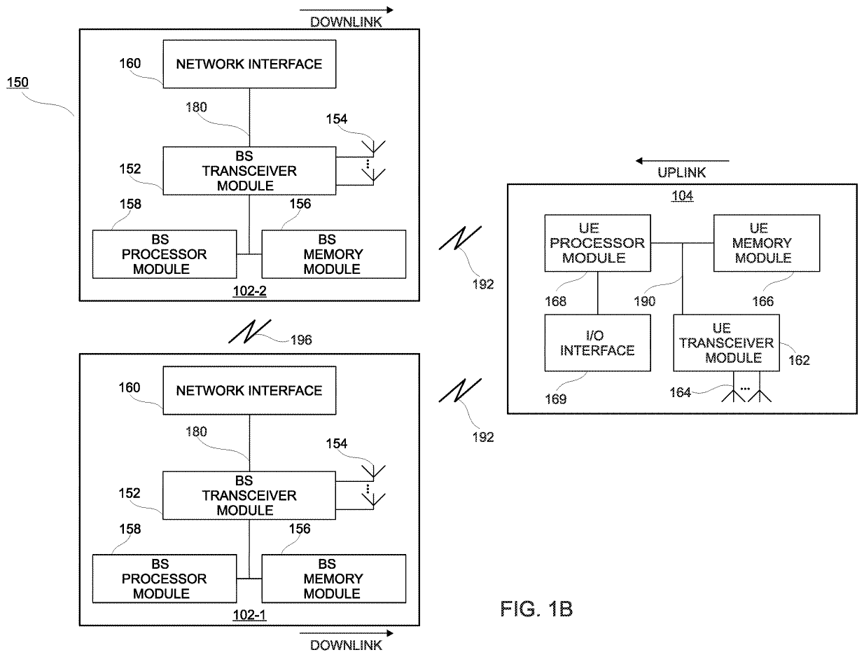

FIG. 1A illustrates an exemplary wireless communication network 100, in accordance with some embodiments of the present disclosure. In a wireless communication system, a network side communication node or a base station (BS) 102 can be a node B, an E-UTRA Node B (also known as Evolved Node B, eNodeB or eNB), a New Generation eNB (ng-eNB), a gNodeB (also known as gNB) in new radio (NR) technology, a pico station, a femto station, a relay, a transmission points (TRP), a road-side unit (RSU), or the like. A terminal side communication device or a user equipment (UE) 104 can be a long range communication system like a mobile phone, a smart phone, a personal digital assistant (PDA), tablet, laptop computer, or a short range communication system such as, for example a wearable device, a vehicle with a vehicular communication system and the like. A network communication node and a terminal side communication device are represented by a BS 102 and a UE 104, respectively, and in all the embodiments in this disclosure hereafter, and are generally referred to as “communication nodes” and “communication device” herein. Such communication nodes and communication devices may be capable of wireless and/or wired communications, in accordance with various embodiments of the invention. It is noted that all the embodiments are merely preferred examples, and are not intended to limit the present disclosure. Accordingly, it is understood that the system may include any desired combination of BSs 102 and UEs 104, while remaining within the scope of the present disclosure.

Referring to FIG. 1A, the wireless communication network 100 includes a first BS 102-1, a first UE 104-1, a second UE 104-2, and a third UE 104-3. In some embodiments, a plurality of UEs 104 may form direct communication (i.e., uplink) channels 103-1, 103-2, and 103-3 with the first BS 102. In some embodiments, the plurality of UEs 104 may also form direct communication (i.e., downlink) channels 105-1, 105-2, and 105-3 with the first BS 102-1. The direct communication channels between the plurality of UEs 104 and a distributed unit of the BS 102 can be through interfaces such as an Uu interface, which is also known as E-UTRAN air interface. In some other embodiments, the direct communication channels between the plurality of UEs 104 and the BS 102 is through 5G New Radio (NR) Radio Access Network (RAN). In some embodiments, the UE 104 comprises a plurality of transceivers which enables the UE 104 to support multi connectivity so as to receive data simultaneously from a plurality of BSs 102-1 to 102-4. Each of the plurality of BSs 102-1 to 102-4 may be connected to a core network (CN) 108 on a user plane (UP) through an external interface 107, e.g., an Iu interface, an NG-U interface, or an S1-U interface. In some embodiments, the CN 108 is one of the following: an Evolved Packet Core (EPC) and a 5G Core Network (5GC). In some embodiments, the CN 108 further comprises at least one of the following: Access and Mobility Management Function (AMF), Location Management Function (LMF), Location Management Server (LMS), User Plane Function (UPF), and System Management Function (SMF).

A direct communication channel 111 between any BSs in the plurality of BSs 102-1 to 102-4 may be implemented through an X2 interface. In some embodiments, the direct communication channel 111 between any BSs in the plurality of BSs 102-1 to 102-4 may be wired, optical or wireless. In some embodiments, a BS (gNB) is split into a Distributed Unit (DU) and a Central Unit (CU) on the UP, between which the direct communication is through a F1-U interface. In some embodiments, a CU of each of the plurality of BSs 102-1 to 102-4 can be further split into a Control Plane (CP) and a User Plane (UP), between which the direct communication is through an E1 interface. Hereinafter in the present disclosure, an Xx interface is used to describe one of the following interfaces, the NG interface, the S1 interface, the X2 interface, the Xn interface, the F1 interface, and the E1 interface. When an Xx interface is established between two nodes, the two nodes can transmit control signaling on the CP and/or data on the UP.

In some embodiments, one of the plurality of UEs 104, such as the UE 104-3 may form direct communication (i.e., uplink) channels 103-3, 203-3, 303-3 and 403-3 with the plurality of BSs 102-1 to 102-4, and the UE 104-3 may also form direct communication (i.e., downlink) channels 105-3, 205-3, 305-3 and 405-3 with the plurality of BSs 102-1 to 102-4. In some embodiments, the UE 104-3 may comprise an Intelligent Reflecting Surface (IRS) 114 attached to the main body of the UE 104-3. The IRS 114 may be referred to as a planar surface comprising a plurality of small, reconfigurable reflecting elements, each of which can induce a controllable amplitude, phase and/or polarization change to the incident signal independently, without any need of baseband processing. In one embodiment, the UE 104-3 is a vehicle, and the IRS 114 may be installed on the roof of the UE 104-3. In another embodiment, the IRS 114 is installed on mobile robots of the UE 104-3. In yet another embodiment, the UE 104-3 is an uncrewed aerial vehicle (UAV) and the IRS 114 is placed facing the ground. In still another embodiment, the UE 104-3 is a handheld device, and the IRS 114 is installed on the UE 104-3. In some embodiments, the UE 104-3 is connected to the IRS 114 through a wire while the UE 104-3 and the IRS 114 are located at different locations. In some other embodiments, the UE 104-3 and the IRS 114 are located at different locations, and the UE 104-3 is connected to the IRS 114 through a wireless communication channel using antennas installed on both the UE 104-3 and the IRS 114. In one embodiment, the IRS 114 is configured to reflect incident signals transmitted from at least one of the plurality of BSs 102-1 to 102-4 for positioning estimation of the UE 104-3, while the UE 104-3 and the IRS 114 are located at different locations. In this embodiment, the UE 104-3 may be configured to transmit a UE message (e.g. UE capability message) to the at least one of the plurality of BSs 102-1 to 102-4, wherein the UE message comprises the location of the IRS 114 (e.g. distance and direction) relative to the UE 104-3. In this way, the at least one of the plurality of BSs 102-1 to 102-4 may determine the exact location of the IRS 114 using the location of the IRS 114 relative to the UE 104-3 and the exact location of the UE 104-3. In another embodiment, the exact location of the IRS 114 is predetermined and transmitted to the at least one of the plurality of BSs 102-1 to 102-4 through the UE message. In yet another embodiment, the exact location of the IRS 114 is predetermined and stored in the at least one of the plurality of BSs 102-1 to 102-4.

In some embodiments, at least one BS from the plurality of BSs 102-1 to 102-4 is configured to generate incident signals to the UE 104-3, and the UE 104-3 may be configured to reflect the incident signals towards specific directions using the installed IRS 114. In some other embodiments, the at least one BS comprises information on the particular cell on which the UE 104-3 is camped, and the at least one BS assigns a specific wireless communication node and the corresponding transmit power to use for the PRS transmissions.

FIG. 1B illustrates a block diagram of an exemplary wireless communication system 150, in accordance with some embodiments of the present disclosure. The system 150 may include components and elements configured to support known or conventional operating features that need not be described in detail herein. In some embodiments, the system 150 can be used to transmit and receive data symbols in a wireless communication environment such as the wireless communication network 100 of FIG. 1A, as described above.

The system 150 generally includes a first BS 102-1, a second BS 102-2, and a UE 104, collectively referred to as BS 102 and UE 104 below for ease of discussion. The first BS 102-1 and the second BS 102-2 each comprises a BS transceiver module 152, a BS antenna array 154, a BS memory module 156, a BS processor module 158, and a network interface 160. In the illustrated embodiment, each module of the BS 102 is coupled and interconnected with one another as necessary via a data communication bus 180. The UE 104 comprises a UE transceiver module 162, a UE antenna 164, a UE memory module 166, a UE processor module 168, and an I/O interface 169. In the illustrated embodiment, each module of the UE 104 is coupled and interconnected with one another as necessary via a date communication bus 190. The BS 102 communicates with the UE 104 via a communication channel 192, which can be any wireless channel or other medium known in the art suitable for transmission of data as described herein.

As would be understood by persons of ordinary skill in the art, the system 150 may further include any number of modules other than the modules shown in FIG. 1B. Those skilled in the art will understand that the various illustrative blocks, modules, circuits, and processing logic described in connection with the embodiments disclosed herein may be implemented in hardware, computer-readable software, firmware, or any practical combination thereof. To clearly illustrate this interchangeability and compatibility of hardware, firmware, and software, various illustrative components, blocks, modules, circuits, and steps are described generally in terms of their functionality. Whether such functionality is implemented as hardware, firmware, or software depends upon the particular application and design constraints imposed on the overall system. Those familiar with the concepts described herein may implement such functionality in a suitable manner for each particular application, but such implementation decisions should not be interpreted as limiting the scope of the present invention.

A wireless transmission from a transmitting antenna of the UE 104 to a receiving antenna of the BS 102 is known as an uplink (UL) transmission, and a wireless transmission from a transmitting antenna of the BS 102 to a receiving antenna of the UE 104 is known as a downlink (DL) transmission. In accordance with some embodiments, the UE transceiver 162 may be referred to herein as an “uplink” transceiver 162 that includes a radio frequency (RF) transmitter and receiver circuitry that is each coupled to the UE antenna 164. A duplex switch (not shown) may alternatively couple the uplink transmitter or receiver to the uplink antenna in time duplex fashion. Similarly, in accordance with some embodiments, the BS transceiver 152 may be referred to herein as a “downlink” transceiver 152 that includes RF transmitter and receiver circuitry that are each coupled to the antenna array 154. A downlink duplex switch may alternatively couple the downlink transmitter or receiver to the downlink antenna array 154 in time duplex fashion. The operations of the two transceivers 152 and 162 are coordinated in time such that the uplink receiver is coupled to the uplink UE antenna 164 for reception of transmissions over the wireless communication channel 192 at the same time that the downlink transmitter is coupled to the downlink antenna array 154. Preferably, there is close synchronization timing with only a minimal guard time between changes in duplex direction. The UE transceiver 162 communicates through the UE antenna 164 with the BS 102 via the wireless communication channel 192. The BS transceiver 152 communications through the BS antenna 154 of a BS (e.g., the first BS 102-1) with the other BS (e.g., the second BS 102-2) via a wireless communication channel 196. The wireless communication channel 196 can be any wireless channel or other medium known in the art suitable for direct communication between BSs.

The UE transceiver 162 and the BS transceiver 152 are configured to communicate via the wireless data communication channel 192, and cooperate with a suitably configured RF antenna arrangement 154/164 that can support a particular wireless communication protocol and modulation scheme. In some exemplary embodiments, the UE transceiver 162 and the BS transceiver 152 are configured to support industry standards such as the Long Term Evolution (LTE) and emerging 5G standards (e.g., NR), and the like. It is understood, however, that the invention is not necessarily limited in application to a particular standard and associated protocols. Rather, the UE transceiver 162 and the BS transceiver 152 may be configured to support alternate, or additional, wireless data communication protocols, including future standards or variations thereof.

The processor modules 158 and 168 may be implemented, or realized, with a general purpose processor, a content addressable memory, a digital signal processor, an application specific integrated circuit, a field programmable gate array, any suitable programmable logic device, discrete gate or transistor logic, discrete hardware components, or any combination thereof, designed to perform the functions described herein. In this manner, a processor module may be realized as a microprocessor, a controller, a microcontroller, a state machine, or the like. A processor module may also be implemented as a combination of computing devices, e.g., a combination of a digital signal processor and a microprocessor, a plurality of microprocessors, one or more microprocessors in conjunction with a digital signal processor core, or any other such configuration.

Furthermore, the steps of a method or algorithm described in connection with the embodiments disclosed herein may be embodied directly in hardware, in firmware, in a software module executed by processor modules 158 and 168, respectively, or in any practical combination thereof. The memory modules 156 and 166 may be realized as RAM memory, flash memory, ROM memory, EPROM memory, EEPROM memory, registers, a hard disk, a removable disk, a CD-ROM, or any other form of storage medium known in the art. In this regard, the memory modules 156 and 166 may be coupled to the processor modules 158 and 168, respectively, such that the processors modules 158 and 168 can read information from, and write information to, memory modules 156 and 166, respectively. The memory modules 156 and 166 may also be integrated into their respective processor modules 158 and 168. In some embodiments, the memory modules 156 and 166 may each include a cache memory for storing temporary variables or other intermediate information during execution of instructions to be executed by processor modules 158 and 168, respectively. The memory modules 156 and 166 may also each include non-volatile memory for storing instructions to be executed by the processor modules 158 and 168, respectively.

The network interface 160 generally represents the hardware, software, firmware, processing logic, and/or other components of the base station 102 that enable bi-directional communication between BS transceiver 152 and other network components and communication nodes configured to communication with the BS 102. For example, network interface 160 may be configured to support internet traffic. In a typical deployment, without limitation, network interface 160 provides an 802.3 Ethernet interface such that BS transceiver 152 can communicate with a conventional Ethernet based computer network. In this manner, the network interface 160 may include a physical interface for connection to the computer network (e.g., Mobile Switching Center (MSC)). The terms “configured for” or “configured to” as used herein with respect to a specified operation or function refers to a device, component, circuit, structure, machine, signal, etc. that is physically constructed, programmed, formatted and/or arranged to perform the specified operation or function. The network interface 160 could allow the BS 102 to communicate with other BSs or a CN over a wired or wireless connection.

Referring again to FIG. 1A, as mentioned above, the BS 102 repeatedly broadcasts system information associated with the BS 102 to one or more UEs 104 so as to allow the UEs 104 to access the network within the cells where the BS 102 is located, and in general, to operate properly within the cell. Plural information such as, for example, downlink and uplink cell bandwidths, downlink and uplink configuration, cell information, configuration for random access, etc., can be included in the system information. Typically, the BS 102 broadcasts a first signal carrying some major system information, for example, configuration of the cell where the BS 102 is located through a Physical Broadcast Channel (PBCH). For purposes of clarity of illustration, such a broadcasted first signal is herein referred to as “first broadcast signal.” It is noted that the BS 102 may subsequently broadcast one or more signals carrying some other system information through respective channels (e.g., a Physical Downlink Shared Channel (PDSCH)).

Referring again to FIG. 1B, in some embodiments, the major system information carried by the first broadcast signal may be transmitted by the BS 102 in a symbol format via the communication channel 192 (e.g., a PBCH). In accordance with some embodiments, an original form of the major system information may be presented as one or more sequences of digital bits and the one or more sequences of digital bits may be processed through plural steps (e.g., coding, scrambling, modulation, mapping steps, etc.), all of which can be processed by the BS processor module 158, to become the first broadcast signal. Similarly, when the UE 104 receives the first broadcast signal (in the symbol format) using the UE transceiver 162, in accordance with some embodiments, the UE processor module 168 may perform plural steps (de-mapping, demodulation, decoding steps, etc.) to estimate the major system information such as, for example, bit locations, bit numbers, etc., of the bits of the major system information. The UE processor module 168 is also coupled to the I/O interface 169, which provides the UE 104 with the ability to connect to other devices such as computers. The I/O interface 169 is the communication path between these accessories and the UE processor module 168.

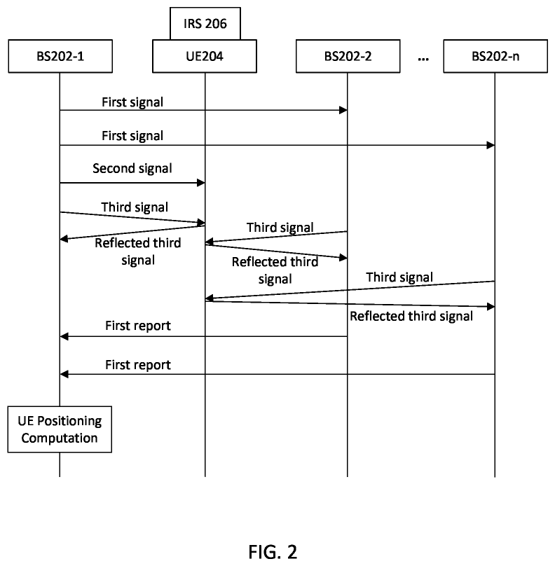

FIG. 2 illustrates a signaling diagram between a plurality of BSs 202-1 to 202-n and a UE 204 for performing a method for UE positioning, in accordance with some embodiments. In some embodiments, the BS 202-1 may be configured to transmit a respective one of a plurality of first signals to a respective one of the BS 202-2 to BS 202-n for performing UE positioning for the UE 204. In some embodiments, the plurality of first signals is transmitted based on a measurement initiation request sent from a location management server (LMS) to the BS 202-1, wherein the measurement initiation request may be an Enhanced Cell Identity (E-CID) measurement initiation request message, an Evolved Universal Terrestrial Radio Access Network Reference Signal Received Power (E-UTRA RSRP) measurement initiation request message, Evolved Universal Terrestrial Radio Access Network Reference Signal Received Quality (E-UTRA RSRQ) measurement initiation request message, or an Observed Time Difference Of Arrival (OTDOA) measurement initiation request message. In some embodiments, the measurement initiation request may indicate a request for UE positioning based on IRS.

In some embodiments, upon receiving the measurement initiation request, the BS 202-1 transmits each of the plurality of first signals to a respective BS from the BS 202-2 to the BS 202-n, wherein each of the plurality of first signals comprises respective downlink positioning reference signal (DL-PRS) configurations, wherein the respective DL-PRS configurations comprise at least one of: positioning reference signal (PRS) resources, muting resources, PRS pattern and periodicity, and a list of measurements to be reported back to the core network, wherein the list of measurements comprises at least one of: a Round-Trip-Delay (RTD), a Time-of-Arrival (ToA), a Received Signal Received Power (RSRP), an Angle-of-Arrival (AoA), and an Angle-of-Departure (AoD) of the PRS transmission. In some embodiments, the BS 202-1 is in direction communication with the BS 202-2 to the BS 202-n, wherein the direction communication is implemented through an X2 interface. In accordance with various embodiments, the direct communication between any BSs in the plurality of BSs 202-1 to 202-n may be wired, optical or wireless.

In some embodiments, after transmitting the plurality of first signals to the BS 202-2 to the BS 202-n, the BS 202-1 may transmit a second signal to the UE 204 for performing UE positioning. In some embodiments, the second signal comprises an indication to instruct the UE 204 to reflect a DL-PRS back towards the corresponding transmitting node that sends the DL-PRS. In some embodiments, the indication instructs the UE 204 to reflect the DL-PRS back to the corresponding transmitting node using an IRS 206 that is installed on the UE 204 or integrated as part of the UE 204. In some other embodiments, the indication instructs the UE 204 to reflect the DL-PRS back to the corresponding transmitting node in the same direction of the incident DL-PRS.

In some embodiments, the second signal sent from the serving cell BS 202-1 to the UE 204 may be transmitted through system information block (SIB) signaling, radio resource control (RRC) signaling, medium access control-control element (MAC-CE) signaling, or downlink control information (DCI) signaling. In some other embodiments, the indication for instructing the UE 204 to reflect the DL-PRS may be pre-configured in the UE 204 or sent to the UE 204 from the serving BS 202-1 via a paging message. In one embodiment, the second signal is transmitted through an SIB Type 1 (SIB1) signaling message, wherein the SIB1 signaling message is periodically transmitted from the serving cell BS 202-1 to the UE 204, such that the SIB1 signaling message can be transmitted to the UE 204 even when the UE 204 is still in IDLE or INACTIVE state.

After transmitting the second signal to the UE 204, each of the plurality of BSs 202-1 to 202-n may be configured to transmit a respective one of a plurality of third signals to the UE 204. In some embodiments, each of the plurality of third signals comprises a respective DL-PRS for performing UE positioning for the UE 204, wherein the respective DL-PRS comprises resource allocation information for downlink transmission, modulation and coding schemes, and pilot/reference signals for UE positioning measurements. In some embodiments, the BS 202-1 transmits the respective third signal to the UE 204 first, then the BSs 202-2 to 202-n transmit their respective third signals to the UE 204 in order. In some other embodiments, the second signal comprises information to inform the UE 204 about DL-PRS transmissions in the plurality of third signals and the order in which the DL-PRS transmissions from the plurality of BSs 202-1 to 202-n will be received at the UE 204.

In some embodiments, after receiving each respective one of the plurality of third signals, instead of performing UE measurements for positioning calculation and transmitting the UE measurement reports back to the serving BS 202-1, the UE 204 may be configured to simply reflect each respective one of the plurality of third signals using the IRS 206. By avoiding transmitting the UE measurement reports back to the serving BS 202-1, the UE 204 does not establish a connection with the serving BS 202-1 during the IRS reflection procedure. Therefore, the UE 204 does not need to be in the CONNECTED state during the transmission of the plurality of third signals. As a result, the power consumption incurred during the transmission of the plurality of third signals can be significantly reduced. In some embodiments, the UE 204 can be in a new POSITIONING state during the transmission of each of the plurality of third signals. In one embodiment, the UE 204 is in a listen-only mode in the new POSITIONING state for reducing power consumption.

In some embodiments, based on the received indication from the second signal, the UE 204 may be configured to reflect each of the plurality of third signals back towards the respective transmitting BS 202 using the IRS 206. In some embodiments, the UE 204 is configured to reflect each of the plurality of third signals in the same direction of the incident signal, such that each reflected one of the plurality of third signals is transmitted back to the respective transmitting BS 202.

In some embodiments, upon receiving the respective reflected one of the plurality of third signals, each of the plurality of BSs 202-1 to 202-n may be configured to perform a respective plurality of UE positioning measurements on the respective reflected one of the plurality of third signals. In some embodiments, the respective plurality of UE positioning measurements comprises at least one of: a Round-Trip Delay (RTD), a Reference Signal Received Power (RSRP), and an Angle of Arrival (AoA). In some embodiments, each of the BS 202-2 to BS 202-n transmits a respective first report back to the serving BS 202-1, wherein the respective first report comprises the respective plurality of UE positioning measurements performed at the respective BS 202. In one embodiment, upon receiving the respective plurality of UE positioning measurements from each of the respective BS 202, the serving BS 202-1 performs UE positioning computation based on the respective plurality of UE positioning measurements.

In some embodiments, after receiving the respective plurality of UE positioning measurements from each of the respective BS 202, the serving BS 202-1 reports each respective plurality of UE positioning measurements to the LMS, which is then configured to perform UE positioning computation based on the each respective plurality of UE positioning measurements. In yet another embodiment, each of the plurality of BSs 202 transmits the respective first report directly to the LMS, and the LMS is configured to perform UE positioning computation based on each of the respective first reports.

In some embodiments, after receiving the reflected respective third signal, each of the plurality of BSs 202 may be configured to compute a respective distance from the UE 204. In one embodiment, the respective distance from the UE 204 is computed by multiplying the propagation velocity of the respective third signal by half of the RTD of the respective third signal for traveling from the respective BS 202 to the UE 204. For example, for the i-th BS 202-i, the respective distance dᵢ between the BS 202-i and the UE 204 is computed by: dᵢ=cᵢ×(0.5×ΔRTDᵢ), where cᵢ denotes the propagation velocity of the i-th third signal generated from the BS 202-i to the UE 204, and ΔRTDᵢ denotes the round-trip delay for the i-th third signal to travel from the BS 202-i to the UE 204 and then back to BS 202-i. In some embodiments, each of the BSs 202-2 to BS 202-n sends the respective first report to the serving BS 202-1, wherein the respective first report comprises the computed respective distance from the respective BS to the UE 204.

In some embodiments, the BS 202-1 performs the UE positioning computation using a trilateration positioning method based on the first reports from the plurality of BSs 202-1 to 202-n. In other embodiments, the serving BS 202-1 transmits the first reports corresponding to the plurality of BSs 202-1 to 202-n to the LMS, and the LMS is configured to perform the UE positioning computation using the trilateration positioning method and the received first reports. In some embodiments, the plurality of BSs 202-1 to 202-n comprises at least three BSs (n≥3), and each of the plurality of BSs 202-1 to 202-n is associated with a respective geographic position expressed in a Cartesian coordinate. For example, the plurality of BSs 202-1, . . . , 202-i, . . . , 202-n may be associated with a respective plurality of Cartesian coordinate: (x₁, y₁), . . . , (xᵢ, yᵢ), . . . , (xₙ, yₙ), wherein the i-th Cartesian coordinate (xᵢ, yᵢ) represents the geographic position of the i-th BS from the plurality of BSs 202-1 to 202-n. In one embodiment, the UE positioning computation for UE 204 is performed using the trilateration positioning method by finding the point (xᵤ, yᵤ) of UE 204 that simultaneously satisfies the following system of equations:

$${( {x}_{u} - {x}_{1} )}^{2} + {( {y}_{u} - {y}_{1} )}^{2} = {d}_{1}^{2}$$

$$⋮$$

$${( {x}_{u} - {x}_{i} )}^{2} + {( {y}_{u} - {y}_{i} )}^{2} = {d}_{i}^{2}$$

$$⋮$$

$${( {x}_{u} - {x}_{n} )}^{2} + {( {y}_{u} - {y}_{n} )}^{2} = {d}_{n}^{2}$$

In some embodiments, for finding the point (xᵤ, yᵤ), the system of equations is solved using one of the following methods: least square method, weighted least square method, total least square method, L1-norm regularization, L2-norm regularization, graphical method, matrix pseudo-inverse method, QR decomposition method, singular value decomposition method, gradient descent method, non-linear optimization methods including (e.g. Nelder-Mead algorithm, the Levenberg-Marquardt algorithm, or the Gauss-Newton method), and principal component regression method. In some embodiments, additional measurements such as RSRP and AoA can be used in the UE positioning computation for achieving higher positioning estimation accuracy in challenging scenarios such as Non-Line-of-Sight (NLOS).

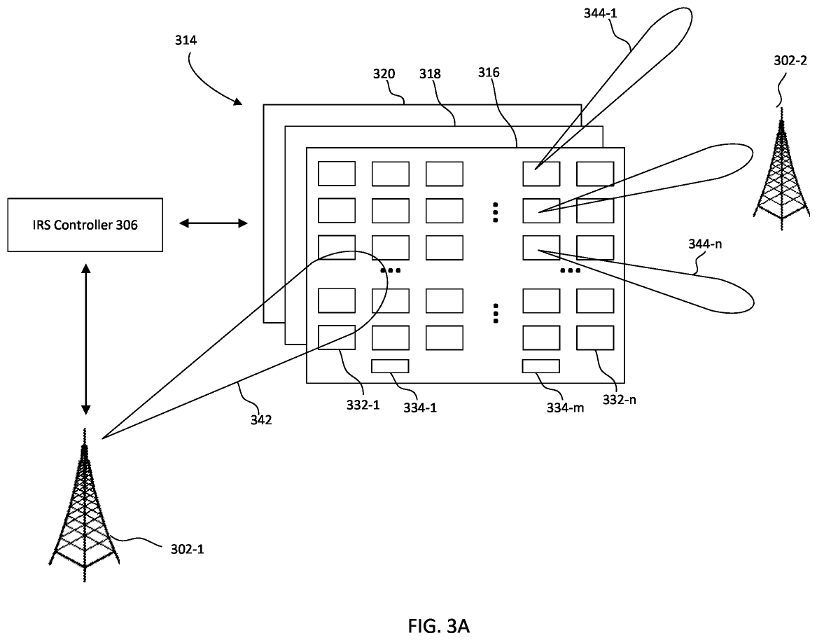

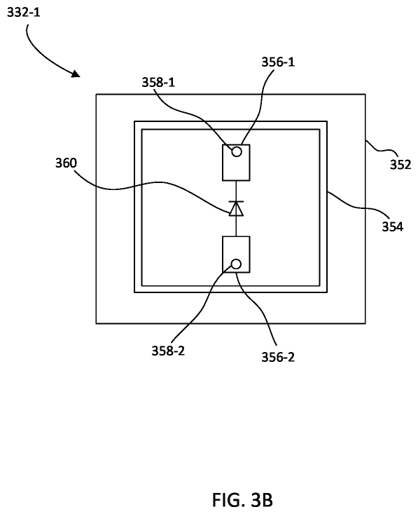

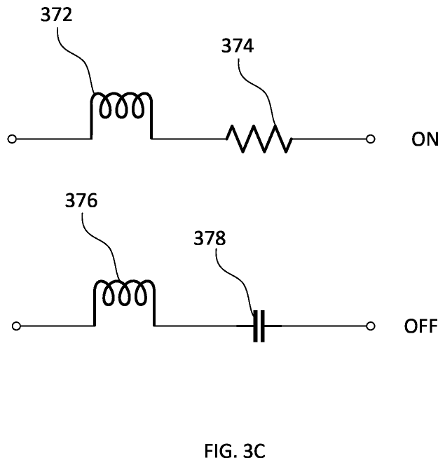

FIG. 3A illustrates an exemplary architecture of IRS for UE positioning, in accordance with some embodiments of the present disclosure. In some embodiments, an IRS 314 comprising a first/outside layer 316, a second/intermediate layer 318 and a third/inside layer can be installed on a UE or integrated as part of the UE for performing UE positioning estimation. In some embodiments, the first/outside layer 316 comprises a plurality of reconfigurable reflecting elements 332-1 to 332-n. In one embodiment, each of the plurality of reconfigurable reflecting elements 332-1 to 332-n comprises a respective metallic patch printed on a dielectric substrate, and each of the respective metallic patches can be configured to manipulate incident signals. In some other embodiments, the second/intermediate layer 318 comprises a copper plate used to reduce signal energy leakage during IRS's reflection. In yet some other embodiments, the third/inside layer 320 comprises a control circuit board, wherein the control circuit board can be configured to activate the plurality of reconfigurable reflecting elements 332-1 to 332-n. In some embodiments, the control circuit board in the third/inside layer 320 is configured to tune the reflection amplitude and/or phase shifts in each of the reconfigurable reflecting elements 332-1 to 332-n at real time.

In some embodiments, an IRS controller 306 can be attached to the IRS 314 for controlling operations in the control circuit board in the third/inside layer 320. Examples of the IRS controller 306 include general purpose processor, digital signal processor (DSP), application specific integrated circuit (ASIC), field programmable gate array (FPGA) or other programmable logic device, or any combination thereof. In one embodiment, the IRS controller acts as a gateway to communicate with other network components in the network through wired or wireless backhaul/control links.

In some embodiments, a plurality of sensors 334-1 to 334-m can be deployed in the first/outside layer 316 to enhance the environmental learning capability of the IRS 314. In one embodiment, each of the plurality of reconfigurable reflecting elements 332-1 to 332-n is associated with a respective sensor from the plurality of sensors 334-1 to 334-m. In another embodiment, the plurality of sensors 334-1 to 334-m is interlaced with the plurality of reconfigurable reflecting elements 332-1 to 332-n in the first/outside layer 316. In yet another embodiment, each of the plurality of sensors 334-1 to 334-m is configured to sense the surrounding radio signals of interest to facilitate the IRS controller 306 in designing the reflection coefficient for the respective one of the plurality of reconfigurable reflecting elements 332-1 to 332-n.

In one embodiment, reflection of incident signals in each of the plurality of reconfigurable reflecting elements 332-1 to 332-n is controlled by mechanical actuation via mechanical rotation. In another embodiment, reflection of incident signals in each of the plurality of reconfigurable reflecting elements 332-1 to 332-n is controlled by functional materials such as liquid crystal or graphene. In yet another embodiment, reflection of incident signals in each of the plurality of reconfigurable reflecting elements 332-1 to 332-n is controlled by electronic devices such as positive-intrinsic-negative (PIN) diodes, field-effect transistors (FETs), or micro-electromechanical system (MEMS) switches. The electronic devices used for controlling reflection of incident signals may provide fast response time, low reflection loss as well as relatively low energy consumption and hardware cost.

FIG. 3B illustrates an expanded view of the reconfigurable reflecting element 332-1 in the IRS 314, in accordance with some embodiments of the present disclosure. In some embodiments, the reconfigurable reflecting element 332-1 comprises a substrate 352, a protective outer metal layer 354, a pair of metal pieces 356-1 and 356-2 connected to two terminals of a PIN diode 360. In some embodiments, each of the pair of metal pieces 356-1 and 356-2 comprises a respective direct-current (DC) feeding via hole 358-1 and 358-2, respectively. In one embodiment, external voltages can be applied to the pair of metal pieces 356-1 and 356-2 using two external probes that are inserted into the via holes 358-1 and 358-2, respectively. By applying different voltage values at the metal pieces 356-1 and 356-2, the PIN diode 360 can be biased to switch between either an “ON” state or an “OFF” state.

FIG. 3C illustrates an exemplary equivalent circuit of the PIN diode 360 when biased to the “ON” state or to the “OFF” state, respectively. In one embodiment, the equivalent circuit of the PIN diode 360 in the “ON” state may be an inductor 372 and a resistor 374 in series as shown. In another embodiment, the equivalent circuit of the PIN diode 360 in the “OFF” state may be an inductor 376 and a capacitor 378 in series as shown. Based on different bias voltage values applied at the two terminals of the PIN diode 360, the PIN diode 360 may exhibit different equivalent circuits as shown in FIG. 3C, and the equivalent values of the components in the equivalent circuits shown in FIG. 3C (e.g. the values of the inductors 372 and 376, the resistor 374 and the capacitor 378) may also change based on the different applied biased voltages at the two terminals of the PIN diode 360.

In some embodiments, different values in the components of the equivalent circuits as shown in FIG. 3C may result in different phase-shift values as compared to the incident signal transmitted to the reconfigurable reflecting element 332-1. As a result, the direction of the reflected signal from the incident signal can be controlled by applying different bias voltage values at the two terminals of the PIN diode 360. The different bias voltage values for the PIN diode 360 can be sent from the IRS controller 306 to the reconfigurable reflecting element 332-1 through the third/inside layer 320. In some embodiments, the switching frequency of the PIN diode 360 may be up to 5 megahertz (MHz), which corresponds to the switching time of 0.2 microsecond (μs). This switching time of 0.2 microsecond is much smaller than a typical channel coherence time that is on the order of millisecond (ms) and thus well suited for mobile applications with time-varying channels.

In some embodiments, besides tuning the phase shift, the reflection amplitude of the reconfigurable reflecting element 332-1 can be also tuned using the IRS controller 306. This additional control of the reflection amplitude may provide more flexibility in reshaping the reflected signal to achieve various communication objectives effectively. This may also offer a flexible way to trade-off between the hardware cost and reflection performance in practice, as amplitude control is generally of lower cost to implement as compared to phase control. In one embodiment, amplitude adjustment of the reconfigurable reflecting element 332-1 is performed by adjusting the load resistance/impedance in the reconfigurable reflecting element 332-1. For example, by changing the resistance of the reconfigurable reflecting element 332-1, a certain portion of the incident signal energy may be dissipated as heat, thus achieving a dynamic range of the reflection amplitude in [0, 1].

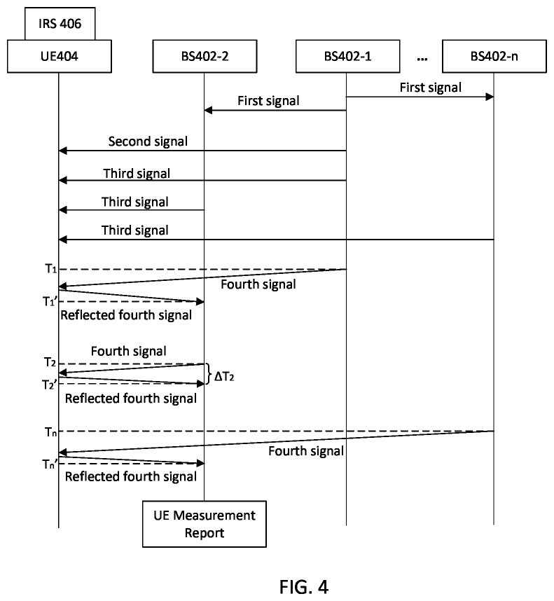

Referring back to FIG. 3A, a serving BS 302-1 may transmit a signal 342 to a UE comprising the IRS 314 for performing UE positioning. In one embodiment, the signal 342 is transmitted through SIB signaling, RRC signaling, MAC-CE signaling, or DCI signaling. In another embodiment, the signal 342 comprises an instruction to instruct the UE to reflect any DL-PRSs back towards the respective transmitting node transmitting the DL-PRS. In yet another embodiment, the BS 302-1 is in direct wired or wireless communication with the IRS controller 306, and the BS 302-1 may send the instruction to the IRS controller 306 such that the IRS controller 306 instructs the UE comprising the IRS 314 to reflect any DL-PRSs back towards the corresponding transmitting node that sends the DL-PRS. In still another embodiment, the signal 342 comprises an instruction to instruct the UE comprising the IRS 314 to reflect DL-PRSs towards specific directions as indicated in the instruction. For example, the signal 342 may comprise an instruction to instruct the UE comprising the IRS 314 to reflect DL-PRSs to the nearest BS 302-2 from the UE, as described in further detail below with reference to FIG. 4. Upon receiving the signal 342, the plurality of reconfigurable reflecting elements 332-1 to 332-n in the IRS 314 may be configured to reflect the signal 342 by producing a respective plurality of reflected signals 344-1 to 344-n based on the instructed reflection directions, as discussed in further detail below.

FIG. 4 illustrates another signaling diagram between a plurality of BSs 402-1 to 402-n and a UE 404 for performing a method for UE positioning, in accordance with some embodiments. In some embodiments, the BS 402-1 may be configured to transmit a respective one from a plurality of first signals to each of the BS 402-2 to BS 402-n for performing UE positioning for the UE 404. In some embodiments, to optimize beam management, at least one of the plurality of BSs 402-1 to 402-n requests an LMS to initiate a UE positioning calculation procedure for the UE 404. In some other embodiments, the plurality of first signals is transmitted based on a measurement initiation request sent from an LMS in the core network, wherein the measurement initiation request may be a new radio (NR) RSRP measurement initiation request, an NR RSRQ measurement initiation request, an E-CID measurement initiation request message, an E-UTRA RSRP measurement initiation request message, an E-UTRA RSRQ measurement initiation request message, or an OTDOA measurement initiation request message. In some embodiments, the measurement initiation request may indicate a request for UE positioning based on IRS.

In some embodiments, upon receiving the measurement initiation request from the LMS, the BS 202-1 transmits the plurality of first signals to the BS 202-2 to the BS 202-n, wherein each of the plurality of first signals comprises DL-PRS configurations, wherein the DL-PRS configurations comprise at least one of: PRS time/frequency (T/F) resources, muting resources, PRS pattern and periodicity, and a list of measurements to be reported back to the core network, wherein the list of measurements comprises at least one of: a RTD, a ToA, an RSRP, an AoA, and an AoD of the PRS transmission. In some embodiments, the BS 402-1 is in direct communication with the BS 402-2 to the BS 402-n, wherein the direct communication is implemented through an X2 interface or an Xn interface for NR communications. In some other embodiments, the direct communication between any BSs in the plurality of BSs 402-1 to 402-n may be wired, optical or wireless.

In some embodiments, after transmitting the plurality of first signals to the BS 402-2 to the BS 402-n, the BS 402-1 is configured to transmit a second signal to the UE 404 for performing UE positioning. In some embodiments, the second signal comprises an indication to instruct the UE 404 to reflect any received DL-PRSs to the nearest BS from the UE 404. In some embodiments, the serving BS 402-1 may be in communication with the IRS controller 306 shown in FIG. 3A, and the second signal may be sent from the IRS controller 306 to the UE 404. In some embodiments, the indication in the second signal instructs the UE 404 to reflect any DL-PRSs towards the nearest BS using an IRS 406 installed on the UE 404 or integrated as part of the UE 404. The functions of the second signal are described above with reference to FIG. 2 and are, therefore, not repeated here.

Reflecting any received DL-PRSs to the nearest BS allows the nearest BS to receive reflected signals with much less signal strength attenuation compared to a faraway BS, since the total propagation loss during the incident path and the reflected path that attenuates the signal strength received at the BS would be higher for a faraway BS. Reduction of signal path loss/attenuation in the reflected signals also allows an implementation of IRS with less reconfigurable reflecting elements as a large number of those reconfigurable reflecting elements are needed to compensate for power loss due to signal attenuation.

In some embodiments, for identifying the nearest BS from the UE 404, each of the plurality of BSs 402-1 to 402-n is configured to transmit a respective one of a plurality of third signals to the UE 404. In one embodiment, the LMS from the core network coordinates with the plurality of BSs 402-1 to 402-n to transmit the respective one of the plurality of third signals at different time points. In another embodiment, each respective one of the plurality of third signals comprises a respective DL-PRS. In yet another embodiment, each respective one of the plurality of third signals is a Single Sideband (SSB) modulation signal for efficient transmission with improved Signal-to-Noise Ratio (SNR). In still another embodiment, the UE 404 is configured to measure a respective RSRP value for each of the plurality of third signals, and identify the nearest BS as the BS that has the strongest RSRP value. In still another embodiment, the serving BS 402-1 may receive information from the LMS or other BSs regarding the nearest BS from the UE 404, and the serving BS 402-1 may directly instruct the UE 404 to reflect any received DL-PRSs to the nearest BS. In some other embodiments, the UE 404 may also be configured to determine an AoA of the respective third signal from the nearest BS.

In one embodiment, the UE 404 determines that the BS 402-2 is the nearest BS as the RSRP value corresponding to the respective third signal transmitted from the BS 402-2 has the strongest RSRP value. In another embodiment, the UE 404 determines that the BS 402-2 is the nearest BS since the BS 402-2 has the shortest RTD with the UE 404. After receiving the plurality of third signals form the plurality of BSs 402-1 to 402-n, each of the plurality of BSs 402-1 to 402-n may be configured to transmit a respective one of a plurality of fourth signals to the UE 404 for UE positioning computation. In some embodiments, each respective one of the plurality of fourth signals comprises a respective DL-PRS for performing UE positioning for the UE 404, wherein the respective DL-PRS comprises resource allocation information for downlink transmission, modulation and coding schemes, and pilot/reference signals for UE positioning measurements. In some other embodiments, the UE 404 may determine the nearest BS using the plurality of fourth signals, such that the plurality of BSs 402-1 to 402-n does not need to transmit the plurality of third signals to the UE 404 for determine the nearest BS. In such cases, the nearest BS is determined based on the plurality of fourth signals, and the UE positioning computation is also performed using the plurality of fourth signals.

In some embodiments, after receiving the plurality of fourth signals, the UE 404 may be configured to reflect each of plurality of fourth signals towards the nearest BS using the IRS 206. For example, if the BS 402-2 is identified as the nearest BS from the UE 404, then each of the plurality of fourth signals is reflected from the UE 404 towards the BS 402-2 as shown in FIG. 4. In one embodiment, the plurality of BSs 402-1, 402-2, . . . , 402-n transmits the respective plurality of fourth signals to the UE 404 at time points T₁, T₂ . . . , Tₙ, respectively as shown in FIG. 4, and the nearest BS from the UE 404 is identified as BS 402-2. In such a case, each of the plurality of fourth signals is reflected back to the nearest BS 402-2 at time points

$${T}_{1}^{′} ,$$

$${T}_{2}^{′} ... , {T}_{n}^{′} ,$$

respectively as shown in FIG. 4. In one embodiment, information of the time points T₁, T₂ . . . , Tₙ corresponding to the transmission times of each of the plurality of fourth signals is transmitted from the serving BS 402-1 to each of the BSs 402-2 to 402-n through the plurality of first signals. In another embodiment, information of the time points T₁, T₂ . . . , Tₙ is directly transmitted from the LMS to the plurality of BSs 402-1 to 402-n before the plurality of fourth signals is transmitted. Suppose that the i-th BS in the plurality of BSs 402-1, 402-2, . . . , 402-n transmits the respective fourth signal at time point Tᵢ, and the UE 404 reflects the respective fourth signal back to its nearest BS 402-2 at time point

$${T}_{i}^{′} ,$$

where i=1, . . . , n, then the time tᵢ for the respective fourth signal to travel from the i-th BS to the UE 404 can be calculated as:

$${t}_{i} = ( {T}_{i}^{′} - {T}_{i} ) - 0.5 \times Δ {T}_{2} ,$$

where ΔT₂ denotes the RTD between the nearest BS 402-2 and the UE 404 and ΔT₂=T₂′−T₂.

In some embodiments, after receiving all the respective reflected fourth signals, the nearest BS 402-2 computes tᵢ where i=1, . . . , n, and sends a UE measurement report to the LMS for UE positioning computation, wherein the UE measurement report comprises the computed tᵢ with i=1, . . . , n. In some embodiments, the UE measurement report further comprises at least one of the following: a respective BS identification (e.g. a gNB ID), a respective physical cell identity (PCI), and a respective NR Cell Global Identity (NCGI) for each of the plurality of BSs 402-1 to 402-n. The LMS may then be configured to perform UE positioning computation using the trilateration method as described above with reference to FIG. 2. In some other embodiments, the nearest BS 402-2 may transmit the UE measurement report comprising only the time points

$${T}_{1}^{′} ,$$

$${T}_{2}^{′} ... , {T}_{n}^{′}$$

to the LMS, and the LMS may be configured to perform UE positioning computation based on

$${T}_{1}^{′} ,$$

$${T}_{2}^{′} ... ,$$

$${T}_{n}^{′}$$

and T₁, T₂ . . . , Tₙ. For example, the LMS may first calculate tᵢ, i=1, . . . , n using the method described above, and then compute the distance dᵢ between the i-th BS and the UE 404 using dᵢ=cᵢ×tᵢ, where cᵢ denotes the propagation velocity of the i-th respective fourth signal transmitted from the i-th BS to the UE 404. In some embodiments, based on the computed dᵢ, i=1, . . . , n, the LMS may perform UE positioning computation using the trilateration method as described above with reference to FIG. 2.

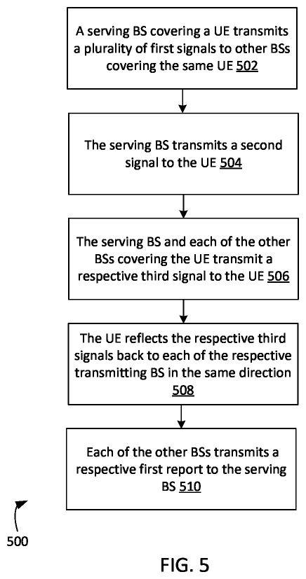

FIG. 5 illustrates an example method 500 for performing UE positioning, in accordance with some embodiments. The operations of method 500 presented below are intended to be illustrative. In some embodiments, method 500 may be accomplished with one or more additional operations not described and/or without one or more of the operations discussed. Additionally, the order in which the operations of method 500 are illustrated in FIG. 5 and described below is not intended to be limiting.

At step 502, a serving BS covering a UE is configured to transmit a plurality of first signals to other BSs covering the same UE. In some embodiments, the plurality of first signals is transmitted based on a measurement initiation request sent from an LMS to the serving BS. In other embodiments, each of the plurality of first signals comprises DL-PRS configurations, wherein the DL-PRS configurations comprise at least one of: PRS resources, muting resources, PRS pattern and periodicity, and a list of measurements to be reported back to the core network, wherein the list of measurements comprises at least one of: an RTD, a ToA, an RSRP, an AoA, and an AoD of the PRS transmission.

At step 504, the serving BS is configured to transmit a second signal to the UE. In some embodiments, the second signal comprises an indication to instruct the UE to reflect a DL-PRS back towards the corresponding transmitting node that sends the DL-PRS. In some embodiments, the indication instructs the UE to reflect the DL-PRS using an IRS that is either installed on the UE or integrated as part of the UE. In some other embodiments, the indication instructs the UE to reflect the DL-PRS back to the corresponding transmitting node in the same direction of the incident signal. In other embodiments, the second signal may be transmitted through SIB signaling, RRC signaling, MAC-CE signaling, or DCI signaling. In yet some other embodiments, the indication may be pre-configured in the UE or sent to the UE from the serving BS via a paging message.

At step 506, the serving BS and each of the other BSs covering the UE transmit a respective third signal to the UE. In some embodiments, each of the respective third signals comprise a respective DL-PRS for performing UE positioning, wherein the respective DL-PRS comprises resource allocation information for downlink transmission, modulation and coding schemes, and pilot/reference signals for UE positioning measurements.

At step 508, the UE is configured to reflect each of the respective third signals back to the respective transmitting BS in the same direction. In one embodiment, the UE is configured to reflect each of the respective third signals using an IRS. In another embodiment, when reflecting each of the respective third signals, the UE avoids sending a UE measurement report back to the serving BS. In this way, the UE does not establish a connection with the serving BS during the IRS reflection procedure. Therefore, the UE does not need to be in the CONNECTED state during the transmission of each of the reflected third signals. As a result, the power consumption incurred during the transmission of each of the reflected third signals can be reduced. In some embodiments, the UE can be in a new POSITIONING state during the transmission of each of the reflected third signals. In yet another embodiment, the UE is in a listen-only mode in the new POSITIONING state for reducing power consumption.

At step 510, after receiving the respective reflected third signal, each of the other BSs transmits a respective first report to the serving BS. In some embodiments, each of the respective first reports comprises a respective plurality of UE positioning measurements performed at the respective BS. In one embodiment, upon receiving the respective plurality of UE positioning measurements from each of the other BSs, the serving BS performs UE positioning computation based on the respective plurality of UE positioning measurements from each of the other BSs. In another embodiment, after receiving the respective plurality of UE positioning measurements from each of the other BSs, the serving BS reports the respective plurality of UE positioning measurements to an LMS, which is then configured to perform UE positioning computation. In yet another embodiment, the UE positioning computation is performed using a trilateration positioning method.

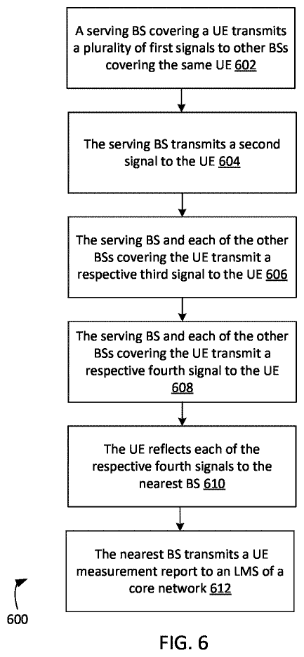

FIG. 6 illustrates another example method 600 for performing UE positioning, in accordance with some embodiments. The operations of method 600 presented below are intended to be illustrative. In some embodiments, method 600 may be accomplished with one or more additional operations not described and/or without one or more of the operations discussed. Additionally, the order in which the operations of method 600 are illustrated in FIG. 6 and described below is not intended to be limiting.

At step 602, a serving BS covering a UE is configured to transmit a plurality of first signals to other BSs covering the same UE. In some embodiments, the plurality of first signals is transmitted based on a measurement initiation request sent from an LMS to the serving BS. In other embodiments, each of the plurality of first signals comprises DL-PRS configurations, wherein the DL-PRS configurations comprise at least one of: PRS resources, muting resources, PRS pattern and periodicity, and a list of measurements to be reported back to the core network, wherein the list of measurements comprises at least one of: an RTD, a ToA, an RSRP, an AoA, and an AoD of the PRS transmission.

At step 604, the serving BS is configured to transmit a second signal to the UE. In some embodiments, the second signal comprises an indication to instruct the UE to reflect any received DL-PRSs to the nearest BS. In some embodiments, the serving BS may be in communication with an IRS controller, and the second signal may be sent from the IRS controller to the UE. In some embodiments, the indication in the second signal instructs the UE 404 to reflect any DL-PRSs towards the nearest BS using an IRS either installed on the UE or integrated as part of the UE. In other embodiments, the second signal may be transmitted through SIB signaling, RRC signaling, MAC-CE signaling, or DCI signaling. In yet some other embodiments, the indication may be pre-configured in the UE or sent to the UE from the serving BS via a paging message.

At step 606, the serving BS and each of the other BSs covering the UE transmit a respective third signal to the UE. In some embodiments, the LMS from the core network coordinates with the serving BS and other BSs covering the UE to transmit the respective third signals at different time points. In some other embodiments, each respective third signal comprises a respective DL-PRS. In yet some other embodiments, the third signal is an SSB modulation signal for efficient transmission with improved SNR. In still some other embodiments, the UE is configured to measure a respective RSRP value for each received respective third signal, and identify the nearest BS as the BS that has the strongest RSRP value. In still some other embodiments, the UE is configured to measure a RTD value for each received respective third signal, and identify the nearest BS as the BS that has the shortest RTD with the UE. In still some other embodiments, the serving BS may receive information from the LMS or other BSs regarding the nearest BS from the UE, and the serving BS may directly instruct the UE to reflect any received DL-PRSs to the nearest BS. In still some other embodiments, the UE may also be configured to determine an AoA of the received third signal from the nearest BS.

At step 608, the serving BS and each of the other BSs covering the UE transmit a respective fourth signal to the UE. In some embodiments, each of the respective fourth signals comprises a respective DL-PRS for performing UE positioning, wherein the respective DL-PRS comprises resource allocation information for downlink transmission, modulation and coding schemes, and pilot/reference signals for UE positioning measurements.

At step 610, the UE is configured to reflect each of the respective fourth signals to the nearest BS. In one embodiment, each of the respective fourth signals is reflected using an IRS. In another embodiment, the transmission time for each of the respective fourth signals is measured at the LMS, and the reception time for each of the respective fourth signals is measured at the UE. In yet another embodiment, the transmission time for each of the reflected respective fourth signals is measured at the UE, and the reception time for each of the reflected respective fourth signals is measured at the nearest BS.

At step 612, the nearest BS transmits a UE measurement report to the LMS of the core network for UE positioning computation. In some embodiments, the UE measurement report comprises a respective computed time for each of the respective fourth signal to travel from each corresponding BS to the UE, and the LMS is configured to perform UE positioning computation using a trilateration method based on the respective computed times.

While various embodiments of the present disclosure have been described above, it should be understood that they have been presented by way of example only, and not by way of limitation. Likewise, the various diagrams may depict an example architectural or configuration, which are provided to enable persons of ordinary skill in the art to understand exemplary features and functions of the present disclosure. Such persons would understand, however, that the present disclosure is not restricted to the illustrated example architectures or configurations, but can be implemented using a variety of alternative architectures and configurations. Additionally, as would be understood by persons of ordinary skill in the art, one or more features of one embodiment can be combined with one or more features of another embodiment described herein. Thus, the breadth and scope of the present disclosure should not be limited by any of the above-described exemplary embodiments.

It is also understood that any reference to an element herein using a designation such as “first,” “second,” and so forth does not generally limit the quantity or order of those elements. Rather, these designations can be used herein as a convenient means of distinguishing between two or more elements or instances of an element. Thus, a reference to first and second elements does not mean that only two elements can be employed, or that the first element must precede the second element in some manner.

Additionally, a person having ordinary skill in the art would understand that information and signals can be represented using any of a variety of different technologies and techniques. For example, data, instructions, commands, information, signals, bits and symbols, for example, which may be referenced in the above description can be represented by voltages, currents, electromagnetic waves, magnetic fields or particles, optical fields or particles, or any combination thereof. Accordingly, as used herein, the terms “transmit” and any tenses thereof, refer to and encompass the sending or propagation of signals via any known wireless, wired or optical transmission mediums and techniques.

A person of ordinary skill in the art would further appreciate that any of the various illustrative logical blocks, modules, processors, means, circuits, methods and functions described in connection with the aspects disclosed herein can be implemented by electronic hardware (e.g., a digital implementation, an analog implementation, or a combination of the two), firmware, various forms of program or design code incorporating instructions (which can be referred to herein, for convenience, as “software” or a “software module), or any combination of these techniques.

To clearly illustrate this interchangeability of hardware, firmware and software, various illustrative components, blocks, modules, circuits, and steps have been described above generally in terms of their functionality. Whether such functionality is implemented as hardware, firmware or software, or a combination of these techniques, depends upon the particular application and design constraints imposed on the overall system. Skilled artisans can implement the described functionality in various ways for each particular application, but such implementation decisions do not cause a departure from the scope of the present disclosure. In accordance with various embodiments, a processor, device, component, circuit, structure, machine, module, etc. can be configured to perform one or more of the functions described herein. The term “configured to” or “configured for” as used herein with respect to a specified operation or function refers to a processor, device, component, circuit, structure, machine, module, etc. that is physically constructed, programmed and/or arranged to perform the specified operation or function.

Furthermore, a person of ordinary skill in the art would understand that various illustrative logical blocks, modules, devices, components and circuits described herein can be implemented within or performed by an integrated circuit (IC) that can include a general purpose processor, a digital signal processor (DSP), an application specific integrated circuit (ASIC), a field programmable gate array (FPGA) or other programmable logic device, or any combination thereof. The logical blocks, modules, and circuits can further include antennas and/or transceivers to communicate with various components within the network or within the device. A general purpose processor can be a microprocessor, but in the alternative, the processor can be any conventional processor, controller, or state machine. A processor can also be implemented as a combination of computing devices, e.g., a combination of a DSP and a microprocessor, a plurality of microprocessors, one or more microprocessors in conjunction with a DSP core, or any other suitable configuration to perform the functions described herein.

If implemented in software, the functions can be stored as one or more instructions or code on a computer-readable medium. Thus, the steps of a method or algorithm disclosed herein can be implemented as software stored on a computer-readable medium. Computer-readable media includes both computer storage media and communication media including any medium that can be enabled to transfer a computer program or code from one place to another. A storage media can be any available media that can be accessed by a computer. By way of example, and not limitation, non-transitory computer-readable media can include RAM, ROM, EEPROM, CD-ROM or other optical disk storage, magnetic disk storage or other magnetic storage devices, or any other medium that can be used to store desired program code in the form of instructions or data structures and that can be accessed by a computer.

In this document, the term “module” as used herein, refers to software, firmware, hardware, and any combination of these elements for performing the associated functions described herein. Additionally, for purpose of discussion, the various modules are described as discrete modules; however, as would be apparent to one of ordinary skill in the art, two or more modules may be combined to form a single module that performs the associated functions according embodiments of the present disclosure.

Additionally, memory or other storage, as well as communication components, may be employed in embodiments of the present disclosure. It will be appreciated that, for clarity purposes, the above description has described embodiments of the present disclosure with reference to different functional units and processors. However, it will be apparent that any suitable distribution of functionality between different functional units, processing logic elements or domains may be used without detracting from the present disclosure. For example, functionality illustrated to be performed by separate processing logic elements, or controllers, may be performed by the same processing logic element, or controller. Hence, references to specific functional units are only references to a suitable means for providing the described functionality, rather than indicative of a strict logical or physical structure or organization.

Various modifications to the implementations described in this disclosure will be readily apparent to those skilled in the art, and the general principles defined herein can be applied to other implementations without departing from the scope of this disclosure. Thus, the disclosure is not intended to be limited to the implementations shown herein, but is to be accorded the widest scope consistent with the novel features and principles disclosed herein, as recited in the claims below.

What is claimed is:

1. A method comprising:
receiving, at a wireless communication device, a respective one of a plurality of first signals transmitted from a respective one of a first plurality of wireless communication nodes, and
reflecting, at the wireless communication device, each of the plurality of first signals back towards the respective one of the first plurality of wireless communication nodes using an Intelligent Reflecting Surface (IRS) coupled to the wireless communication device for positioning computation of the wireless communication device.

2. The method of claim 1, wherein the first plurality of wireless communication nodes comprises a first wireless communication node and a second plurality of wireless communication nodes, the method further comprising:
receiving, at the first wireless communication node, a respective one of a plurality of first reports from a respective one of the second plurality of wireless communication nodes.

3. The method of claim 2, wherein
prior to transmitting the respective one of the plurality of first signals:
transmitting, by the first wireless communication node, a respective one of a plurality of second signals to each of the second plurality of wireless communication nodes,
transmitting, by the first wireless communication node, a third signal to the wireless communication device, wherein the third signal comprises an indication to instruct the wireless communication device to reflect signals back towards a respective transmitting node using the IRS.

4. The method of claim 3, wherein:
each of the plurality of second signals comprises respective downlink-positioning reference signal (DL-PRS) configurations for each of the first plurality of wireless communication nodes, wherein the respective DL-PRS configurations comprise at least one of:
positioning reference signal (PRS) resources,
muting resources,
a PRS pattern and a PRS periodicity, and
a respective list of measurements to be reported in the respective one of the plurality of first reports, wherein the respective list of measurements comprises at least one of: a Round-Trip-Delay (RTD), a Time-of-Arrival (ToA), a Received Signal Received Power (RSRP), an Angle-of-Arrival (AoA), and an Angle-of-Departure (AoD) for PRS transmissions; and
the respective transmitting node is a respective one of the first plurality of wireless communication nodes.

5. The method of claim 3, wherein the indication in the third signal is:
transmitted through system information block (SIB) signaling;
transmitted through radio resource control (RRC) signaling;
transmitted through medium access control-control element (MAC-CE) signaling;
transmitted through downlink control information (DCI) signaling;
transmitted via a paging message; or
pre-configured in the wireless communication device.

6. The method of claim 1, wherein the respective one of the plurality of first signals comprises a respective downlink-positioning reference signal (DL-PRS), wherein the respective DL-PRS comprises at least one of:
resource allocation information for downlink transmission;
modulation and coding schemes; and
pilot signals for positioning measurements.

7. The method of claim 1, wherein the wireless communication device is in a non-CONNECTED state when the wireless communication device reflects each of the plurality of first signals back towards the respective one of the first plurality of wireless communication nodes using the IRS.

8. The method of claim 3, wherein the first wireless communication node is further configured to:
after receiving the plurality of first reports:
transmit the plurality of first reports to a Location Management Server (LMS), wherein the LMS is configured to perform positioning computation for the wireless communication device using a trilateration positioning method based on the plurality of first reports.

9. A non-transitory computer readable medium storing computer-executable instructions which when executed perform the method of claim 1.

10. A processor configured to perform the method of claim 1.

11. A communication system comprising the wireless communication device and the first plurality of wireless communication nodes of claim 1, wherein the communication system is configured to perform the method of claim 1.

12. A wireless communication device comprising:
a receiver configured to receive a respective one of a plurality of first signals transmitted from a respective one of a first plurality of wireless communication nodes, and
a transceiver configured to reflect each of the plurality of first signals back towards the respective one of the first plurality of wireless communication nodes using an Intelligent Reflecting Surface (IRS) coupled to the wireless communication device for positioning computation of the wireless communication device.

13. A method comprising:
receiving, at a first wireless communication device, a respective one a plurality of first signals transmitted from a respective one of a first plurality of wireless communication nodes,
reflecting, at the first wireless communication device, each of the plurality of first signals to a nearest wireless communication node using an Intelligent Reflecting Surface (IRS) coupled to the wireless communication device for positioning computation of the wireless communication device.

14. The method of claim 13, further comprising transmitting, by the nearest wireless communication node, a measurement report to a Location Management Server (LMS).

15. The method of claim 13, wherein the first plurality of wireless communication nodes comprises a first wireless communication node and a second plurality of wireless communication nodes:
prior to transmitting the respective one of the plurality of first signals:
transmitting, by the first wireless communication node, a respective one of a plurality of second signals to each of the second plurality of wireless communication nodes;
transmitting, by the first wireless communication node, a third signal to the wireless communication device, wherein the third signal comprises an indication to instruct the wireless communication device to reflect signals to the nearest wireless communication node from the wireless communication device using the IRS; and
transmitting, by the first wireless communication node, a respective one of a plurality of fourth signals to the wireless communication device, wherein the wireless communication device is configured to receive each of the plurality of fourth signals from a respective one of the first plurality of wireless communication nodes for determining the nearest wireless communication node.

16. The method of claim 15, wherein:
each of the plurality of second signals comprises respective downlink-positioning reference signal (DL-PRS) configurations for each of the second plurality of wireless communication nodes, wherein the respective DL-PRS configurations comprise at least one of:
positioning reference signal (PRS) resources;
muting resources;
a PRS pattern and a PRS periodicity; and
a respective list of measurements to be reported in the respective one of the plurality of first reports, wherein the respective list of measurements comprises at least one of: a Round-Trip-Delay (RTD), a Time-of-Arrival (ToA), a Received Signal Received Power (RSRP), an Angle-of-Arrival (AoA), and an Angle-of-Departure (AoD) for PRS transmission.

17. The method of claim 13, wherein the indication in the third signal is:
transmitted through system information block (SIB) signaling;
transmitted through radio resource control (RRC) signaling;
transmitted through medium access control-control element (MAC-CE) signaling;
transmitted through downlink control information (DCI) signaling;
transmitted via a paging message; or
pre-configured in the wireless communication device.

18. The method of claim 13, wherein the respective one of the plurality of first signals comprises a respective downlink-positioning reference signal (DL-PRS), wherein the respective DL-PRS comprises at least one of:
resource allocation information for downlink transmission;
modulation and coding schemes; and
pilot signals for positioning measurements.

19. The method of claim 13, wherein the wireless communication device is in a non-connected state when the wireless communication device reflects each of the plurality of first signals to the nearest wireless communication node using the IRS.

20. The method of claim 15, wherein the nearest wireless communication node is determined based on:
a plurality of Received Signal Received Power (RSRP) values, wherein each of the plurality of RSRP values corresponds to the respective one of the plurality of fourth signals, or
a plurality of Round-Trip-Delay (RTD) values, wherein each of the plurality of RTD values corresponds to the respective one of the plurality of fourth signals.

21. The method of claim 13, wherein the measurement report comprises a plurality of time points, wherein each of the plurality of time points corresponds to a respective arrival time of a respective reflected one of the plurality of first signals at the nearest wireless communication node.

22. A non-transitory computer readable medium storing computer-executable instructions which when executed perform the method of claim 13.

23. A processor configured to perform the method of claim 13.

24. A communication system comprising the wireless communication device and the first plurality of wireless communication nodes of claim 13, wherein the communication system is configured to perform the method of claim 13.

25. A wireless communication device comprising:
a receiver configured to receive a respective one a plurality of first signals transmitted from a respective one of a first plurality of wireless communication nodes,
a transceiver configured to reflect each of the plurality of first signals to a nearest wireless communication node using an Intelligent Reflecting Surface (IRS) coupled to the wireless communication device, for positioning computation of the wireless communication device.

26. A method performed by a first wireless communication node, the method comprising:
transmitting a respective one of a plurality of first signals to a wireless communication device, wherein the first plurality of wireless communication nodes comprises the first wireless communication node and a second plurality of wireless communication nodes, and
prior to transmitting the respective one of the plurality of first signals,
transmitting a respective one of a plurality of second signals to each of the second plurality of wireless communication nodes,
transmitting a third signal to the wireless communication device, wherein the third signal comprises an indication to instruct the wireless communication device to reflect signals to the nearest wireless communication node from the wireless communication device using the IRS.

27. The method of claim 26, wherein
prior to transmitting the respective one of the plurality of first signals,
transmitting a respective one of a plurality of fourth signals to the wireless communication device, wherein the wireless communication device is configured to receive each of the plurality of fourth signals from a respective one of the first plurality of wireless communication nodes for determining the nearest wireless communication node.
